(19) United States
(12) Patent Application Publication
(10) Pub. No.: US 2011/0145978 A1
(43) Pub. Date: Jun. 23, 2011

(54) ARTICLE OF HEADGEAR

(75) Inventor: Daniel Harbin, Tamworth (GB)

(73) Assignee: BIRMINGHAM CITY UNIVERSITY, Birmingham (GB)

(21) Appl. No.: 12/743,186

(22) PCT Filed: Nov. 17, 2008
(86) PCT No.: PCT/GB08/03853

§ 371 Date: Feb. 10, 2011

(30) Foreign Application Priority Data
Nov. 16, 2007 (GB) 0722592.3

(51) Int. Cl. A42B 1/24; B23P 17/04

(52) U.S. Cl. 2/209.13; 29/592

(57) ABSTRACT

An article of headgear, particularly but not limited to surgeon's headgear, comprises a frame 12, a lighting arrangement 68 on the frame arranged to point generally towards a focal point in front of the frame. The headgear is arranged such that, when worn on the head of a user, the centre of gravity of the headgear 78 is arranged rearwardly relative to the nodding pivot point of the head of the user. The frame 12 has a front part and a rear part. The front part carries a piece of optical equipment 104 and the rear part carries a lighting arrangement 68 or power source. The weight of the lighting arrangement 68 or power source at least partially counterbalances the weight of the optical equipment 104 or vice versa. The article of headgear 78 comprises a band 12 for arranging around a part of a user's head, a frame 14 for carrying optical equipment 104 mounted to the band so as to extend, in use, around a user's eyes, part of the band extending, in use, over the crown of the user's head and the band bearing at least part of the weight of the frame.

The band 12 has a front curved band part 16, two side band parts 18 extending from opposite ends of the front curved band part, the side band parts curving out of the plane defined by the front curved band part, and a rear band part 24 extending between the ends of the side band parts and spaced from the front curved band part. When the article of headgear is worn by a user, the side band parts 18 extend along the parietal bones of the skull to reduce substantially load applied to the sphenoid or temporal bones. Preferably, the frame is mounted on the band, the band supporting the frame in such a way that, in use, substantially no weight is applied to the nose of a user.

The invention further envisages a method of fitting an article of surgical headgear to a user comprising the steps of:
scanning the head of the user using a laser scanning arrangement,
using data from the scan to determine a set of dimensions of the head of the user,
using the set of dimensions to design the shape and size of the article of surgical headgear.

This invention relates to an article of headgear and particularly, although not exclusively limited to headgear for use by surgeons.

Due to advances in medicine, surgeons are performing increasingly intricate operations on patients, even as young as one month old. Due to the detail and intricacy of the surgical work, additional equipment is required by the surgeon to increase the chances of success of the operation. Typically, a surgeon requires some means to magnify the wound area and appropriately bright lighting is required. Also, it can be desirable, for training and legal purposes, to video the operation. Typically, all of this equipment is accommodated on the head of the surgeon connected to a whole host of equipment, with associated cables and fibre optics, on a separate trolley, which is needed to run the headgear.

Generally, surgeons wear three separate items of equipment: loupes, a headlight and a video camera. Loupes are special glasses which include a set of magnification lenses that protrude forward of the surgeon's face at an acute angle. Loupes tend to be unique to each surgeon as they are opthalmically specific. Loupes are generally worn in the same way as a standard pair of glasses but they have a much higher weight due to the large magnifying lenses used. This weight can push down against the surgeon's nose and cheeks and cause discomfort, particularly in lengthy operations. The weight of the magnifying lenses at the front of the surgeon's face causes the loupes to fall forward when the surgeon looks down to see into the patient and consequently the surgeon must attach a loupe strap that passes around the back of the head to hold the loupes on. The loupe strap is necessarily tight, to maintain position, and the strap and frames can cause irritation due to rubbing or chafing on the ears.

A surgeon typically wears a headband that carries the headlight and the video camera (see FIG. 3). The headlight is made up of a light output mounted on the headband at the front of the surgeon's face just above the nose. A light source is provided, which normally comprises a large box containing a xenon or metal halide bulb, with the light fed along fibre-optic cables connected to the rear of the surgeon's gown by clips and then to the light output. This arrangement substantially limits mobility of the surgeon as the light source, which is heavy and connected to a mains power supply, must travel with the surgeon due to the fibre-optic cable connection. Also, the clipping of the fibre-optic cables to the surgeon's gown is undesirable as it restricts movement. Also, a substantial part of the weight of the fibre-optic cables is carried by the head of the surgeon. The existing equipment takes a long time to set up and can move and become misaligned during surgery. Realignment requires another person because the equipment is not sterilised.

The video camera is clipped to the headband next to or on top of the light output and a power/signal cable is connected to the video camera to enable it to function. As the headband carries a lot of weight and as the light source and video camera must follow the movement of the surgeon's head precisely, the headband must be arranged around the surgeon's head tightly.

A combination of the heavy loupes and the tight, heavy surgeon's headband with headlight and video camera causes fatigue, headaches, stiff necks, muscular pain, and bruising caused by pressure points on the head of the surgeon due to tightening of the head band. Eventually, there is the potential for prolapsed vertebrae to occur due to the surgeon supporting the weight of the head gear while looking down for extended periods of time into a surgical wound. Consequently, the take-up by surgeons of light equipment and video equipment is low despite the usefulness of that equipment. However, increasingly, the use of video equipment may become a legal requirement to record operations for suit protection and other matters.

The weight of the current equipment described above can be over half a kilogram, which is a large amount of weight to be held on the surgeon's head for long periods of time, particularly when it is held in a single position with a surgeon's head looking downwardly, thus placing great stress on the neck and upper back.

Moreover, the bulbs used in the light source boxes burn out frequently. Typically, after 300 and 60 hours for the xenon and metal halide bulbs respectively. This means that a metal halide bulb will only last for 15 operations of four hours length.

It is an object of the invention to provide an improved article of headgear.

Turning to a first aspect of the invention, there is provided surgical headgear comprising a frame, a lighting arrangement on the frame arranged to point generally towards a focal point in front of the frame, the headgear being arranged such that, when worn on the head of a user, the centre of gravity of the headgear is arranged rearwardly relative to the nodding pivot point of the head of the user.

In that way, when the surgeon wears the headgear in accordance with the above first aspect of the invention and operates, the head is tipped to enable the surgeon to look at the patient. In that position, the centre of gravity of the headgear will act downwardly through the spine rather than substantially forward of the nodding pivot point of the head of the user. The latter only adds to the moment applied to the neck and spine by tilting the head downwardly by the surgeon to view the patient.

According to a second aspect of the invention, there is provided an article of headgear comprising a frame having a front part and a rear part, the front part carrying a piece of optical equipment and the rear part carrying a lighting arrangement or power source, whereby the weight of the lighting arrangement or power source at least partially counterbalances the weight of the optical equipment or vice versa.

In that way, the heavy loupes are counterbalanced by the weight of the light or power source on the rear of the frame.

According to a third aspect of the invention there is provided an article of headgear comprising a band for arranging around a part of a user's head, a frame for carrying optical equipment mounted to the band so as to extend, in use, around a user's eyes, part of the band extending, in use, over the crown of the user's head and the band bearing at least part of the weight of the frame.

In that way, the weight of the loupes is borne by the crown part of the head rather than the ears and nose of the user. To aid stability, the band may grip at the sides of the users head, approximately behind the ears, and away from the Temporal muscles. Also, the absence of a strap prevents chafing of the ears as the head moves and maintains position with minimal pressure.

According to a fourth aspect of the invention there is provided an article of headgear comprising a band for arranging on a user's head, the band having a front curved band part, two side band parts extending from opposite ends of the front curved band part, the side band parts curving out of the plane defined by the front curved band part, and a rear band part extending between the ends of the side band parts and spaced from the front curved band part, whereby, when the article of headgear is worn by a user, the side band parts extend along the parietal bones of the skull to reduce substantially load applied to the sphenoid or temporal bones.

In that way, the weight of the headgear is borne by the side band parts which extend along the parietal bones of the user. Load borne on the parietal bones is less likely to cause pressure headaches than in the previously known headbands which extend circumferentially around the head, applying pressure to the temples of the user. In the fourth aspect of the invention, the front curved band part extends around the forehead of the user, the side band parts extend over the parietal bones along the side of the user's head and the rear band part will usually extend around the occipital bone to prevent the headgear from slipping off the user's head when the surgeon tips the head forward to look at the patient. Pressure in the headband is preferably evenly distributed around its periphery, avoiding high pressure points and applying the pressure to less sensitive parts of the head.

According to a fifth aspect of the invention there is provided an article of surgical headgear comprising a band arranged to extend at least partly around a head of a user, a frame carrying a pair of loupes, the frame being mounted on the band, the band supporting the frame in such a way that, in use, substantially no weight is applied to the nose of a user.

According to a sixth aspect of the invention there is provided a method of fitting an article of surgical headgear to a user comprising the steps of:

scanning the head of the user using a laser scanning arrangement,

using data from the scan to determine a set of dimensions of the head of the user,

using the set of dimensions to design the shape and size of the article of surgical headgear.

Other advantageous features of the above aspects of the invention are set out in the claims appended hereto.

It is envisaged that other applications beyond surgeon's headgear can be found for the headgear described above. In particular, other operating theatre staff may benefit, as could the emergency services, dental surgeons and cameramen, or even sports participants, e.g. rock climbers, skiers, sky divers. Other professionals or tradesman requiring good vision of intricate work and/or use of lighting and video cameras while having both hands free could find the devices useful, such as mechanics, jewellers, craftsmen etc.

Embodiments of the above aspects of the invention will now be described in detail by way of example and with reference to the accompanying drawings, in which:

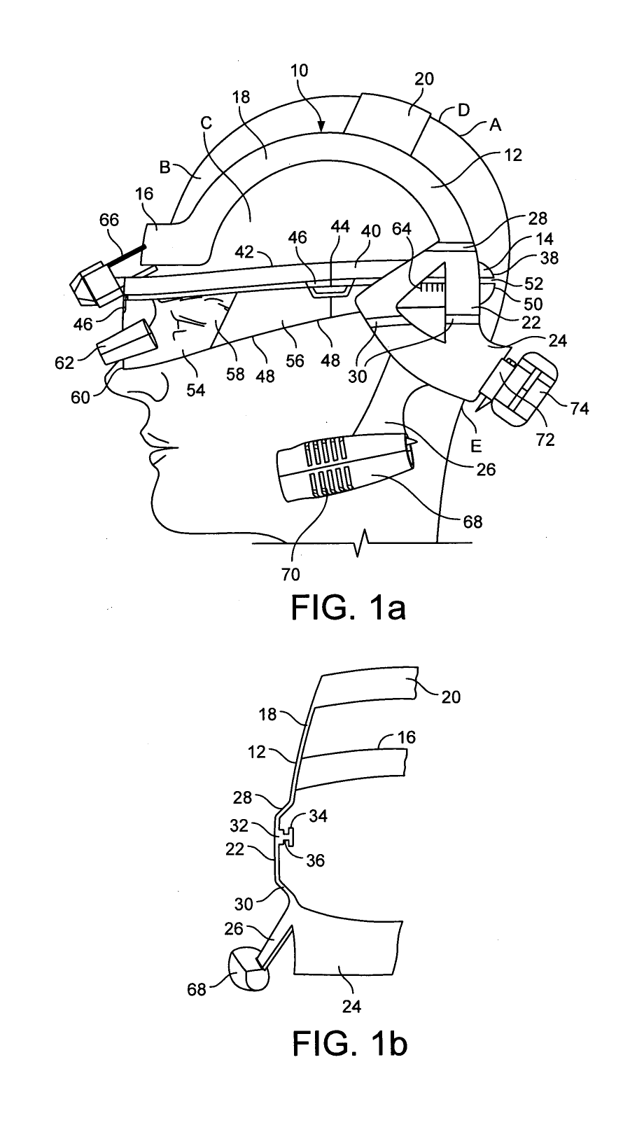

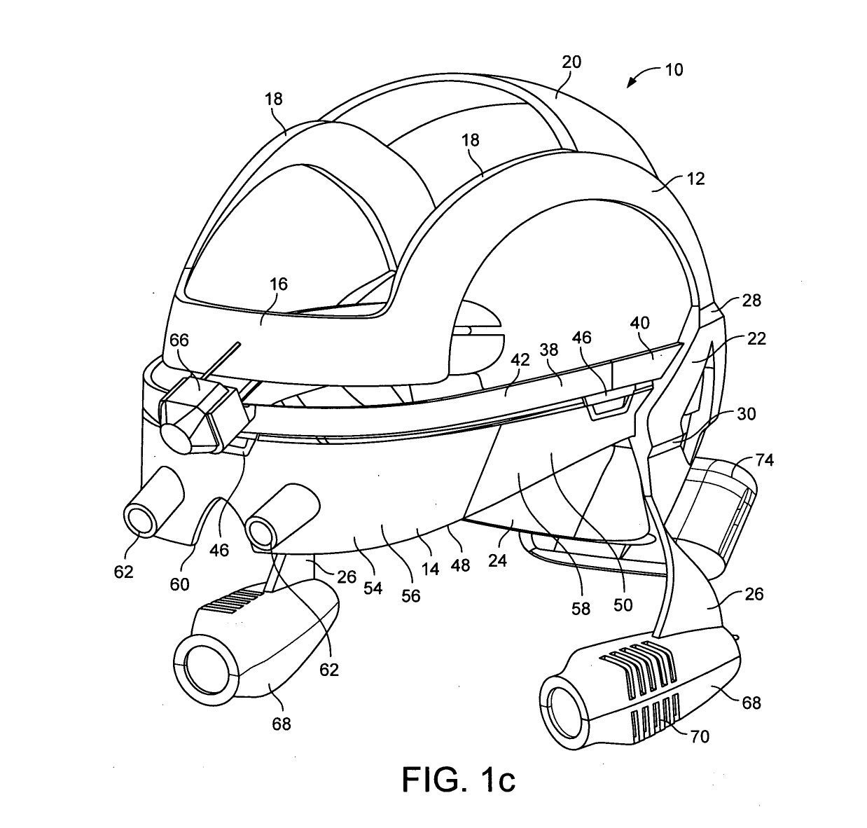

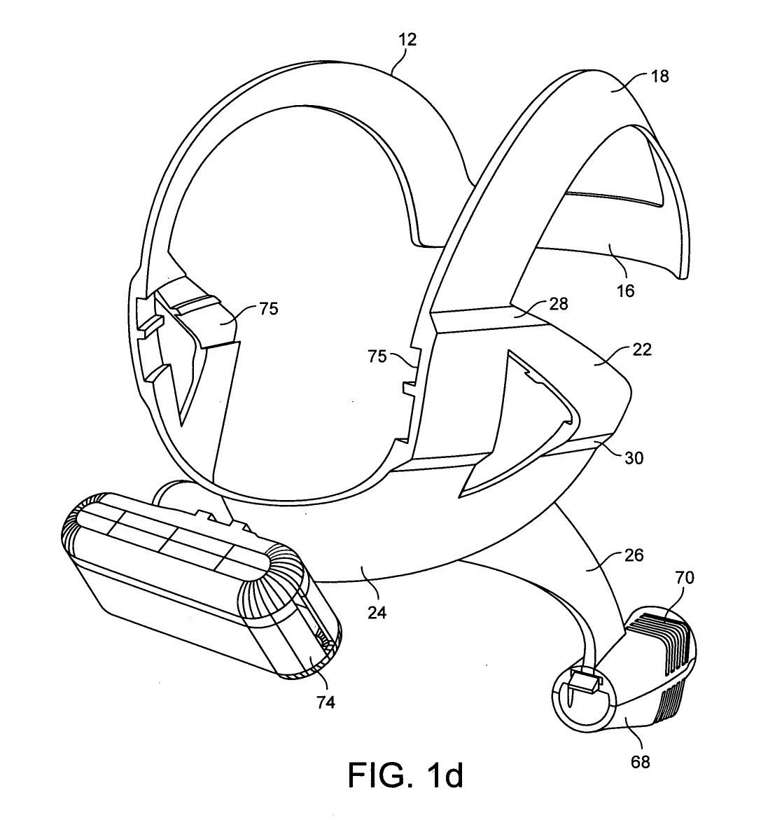

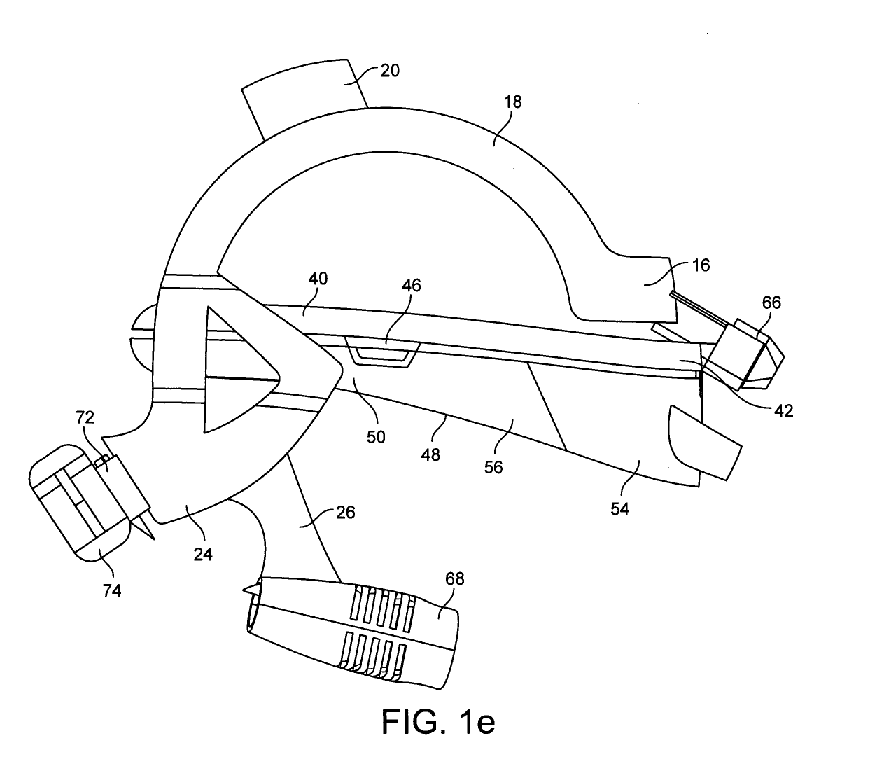

FIG. 1a is a side elevation of an article of surgical headgear in accordance with the first to fourth aspect of the invention shown on the head of a user,

FIG. 1b is an end elevation of the left half of the surgical headgear in FIG. 1a viewed in the direction of arrow B in FIG. 1a omitting various parts for clarity,

FIG. 1c is a perspective view of the surgical headgear of FIGS. 1a and 1b, looking from the front and to one side thereof,

FIG. 1d is a perspective view of the surgical headgear of FIGS. 1a to 1c looking from the rear and to the opposite side of FIG. 1c omitting the crown strap 20 and spectacle frame 14 for clarity,

FIG. 1e is a side elevation of the surgical headgear of FIGS. 1a to 1d.

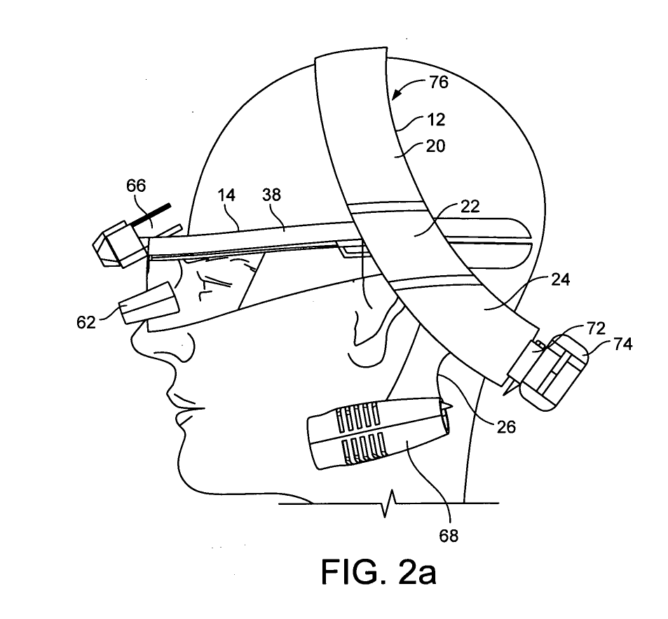

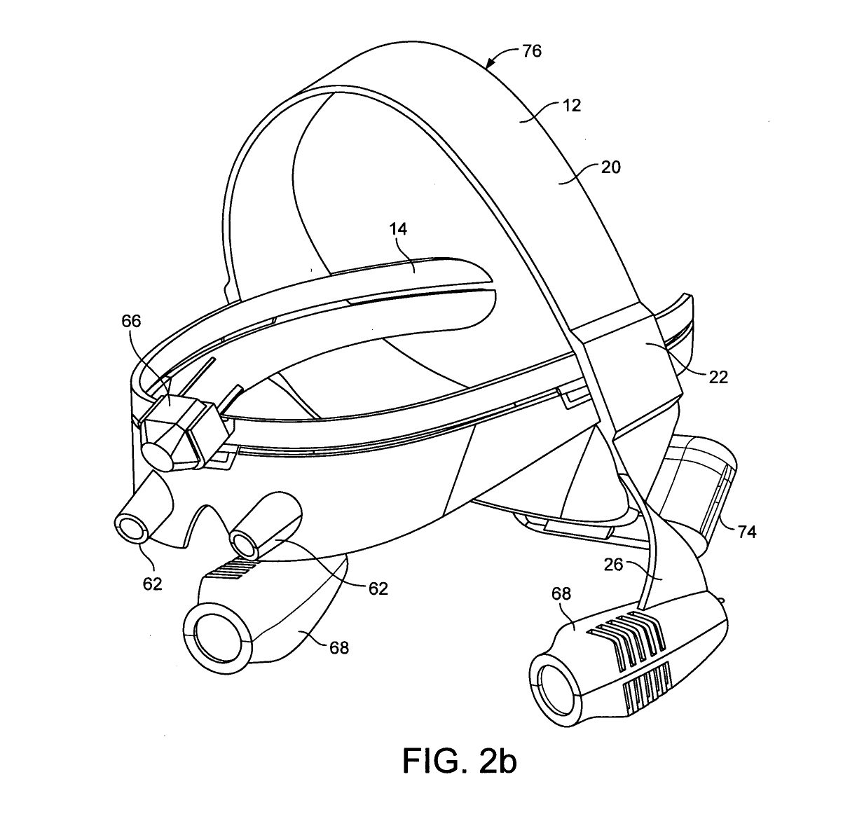

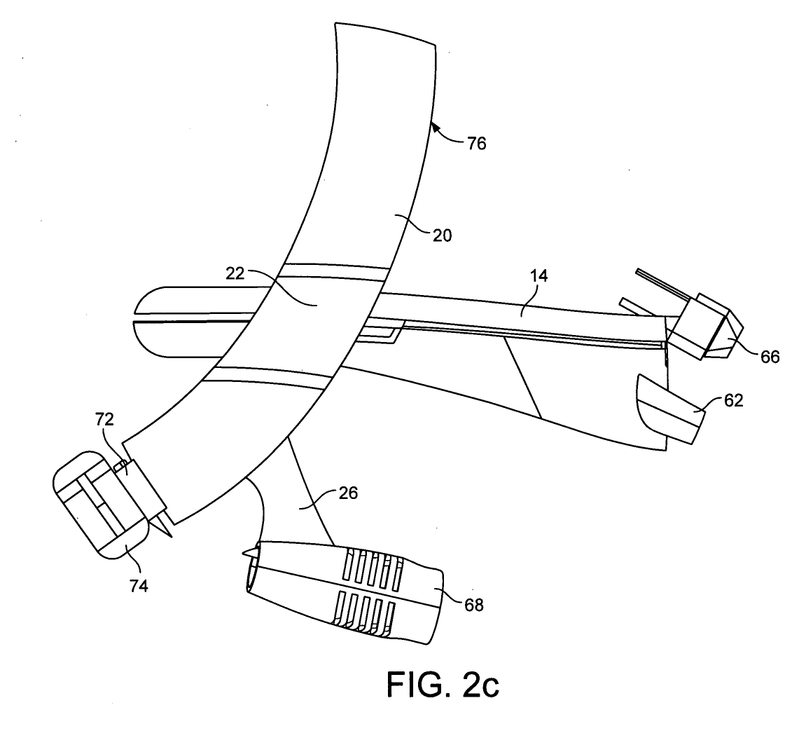

FIG. 2a is a side elevation of another article of headgear in accordance with the first to third aspects of the invention,

FIG. 2b is a perspective view of the surgical headgear of FIG. 2a looking from the front and to one side,

FIG. 2c is a side elevation of the surgical headgear of FIGS. 2a and 2b.

FIG. 3 is a picture of a surgeon wearing prior art headgear,

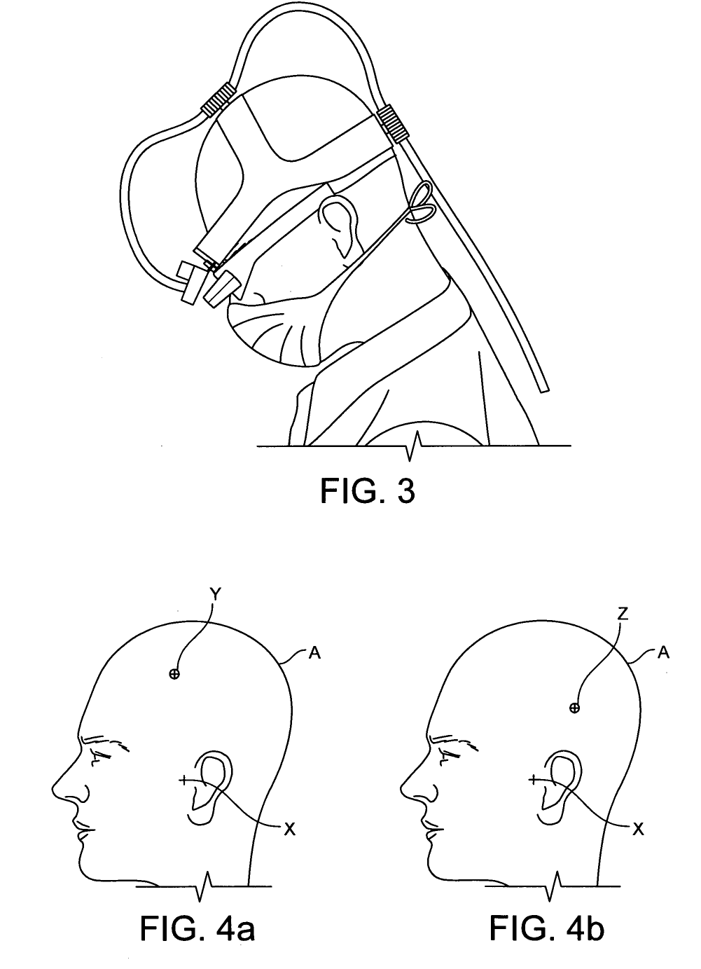

FIGS. 4a and b are side elevations of the user's head showing the centres of gravity of the prior art headgear and the headgear in accordance with the present invention,

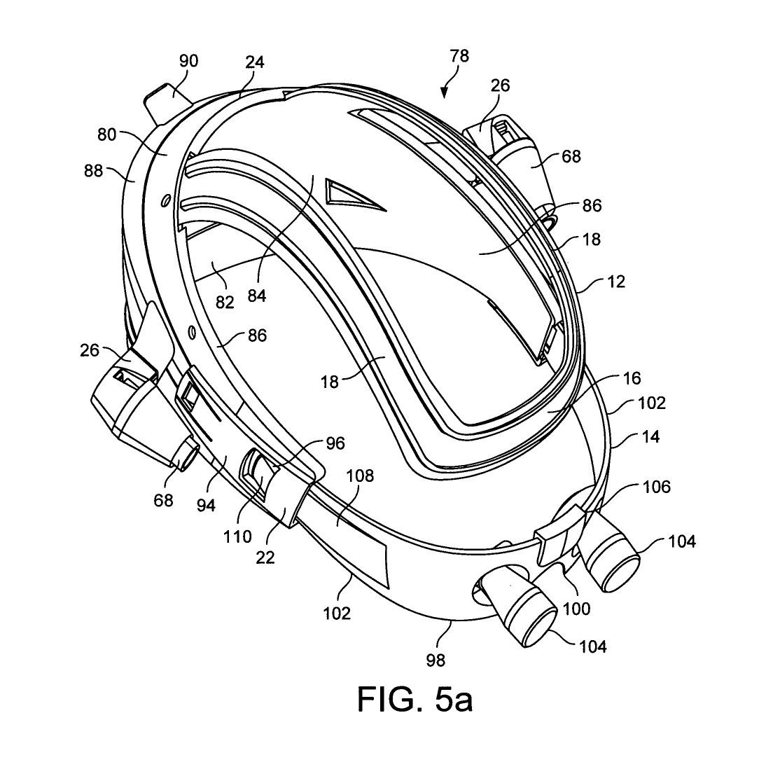

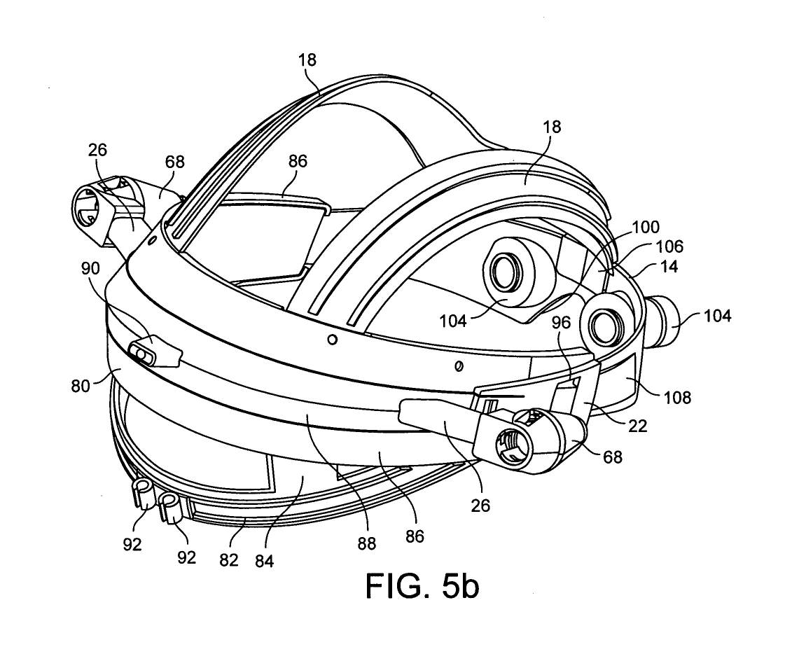

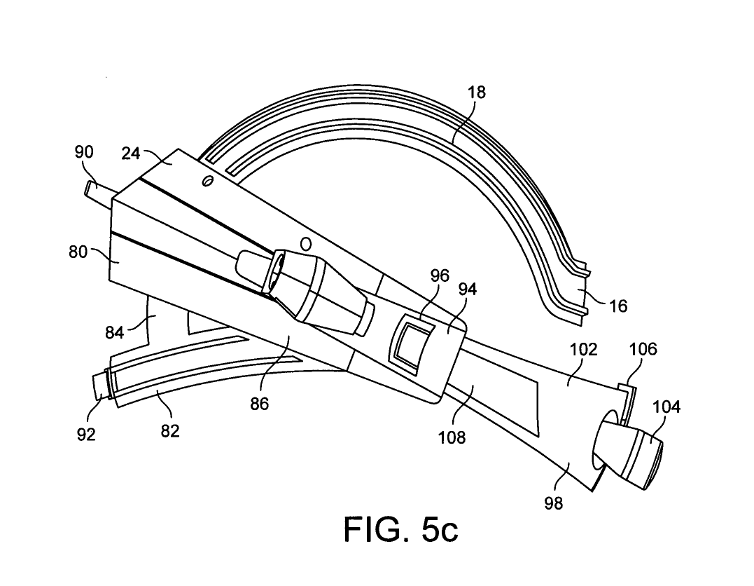

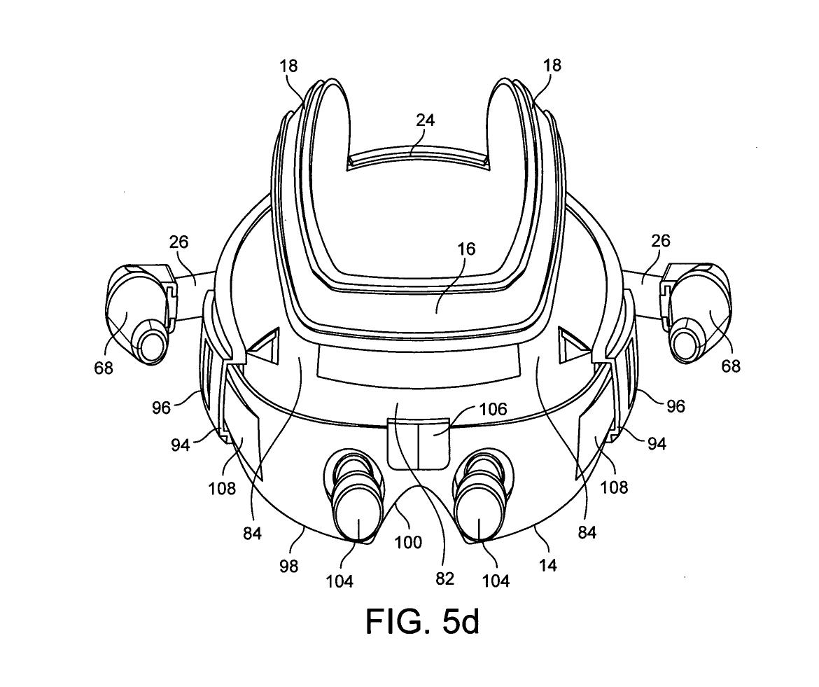

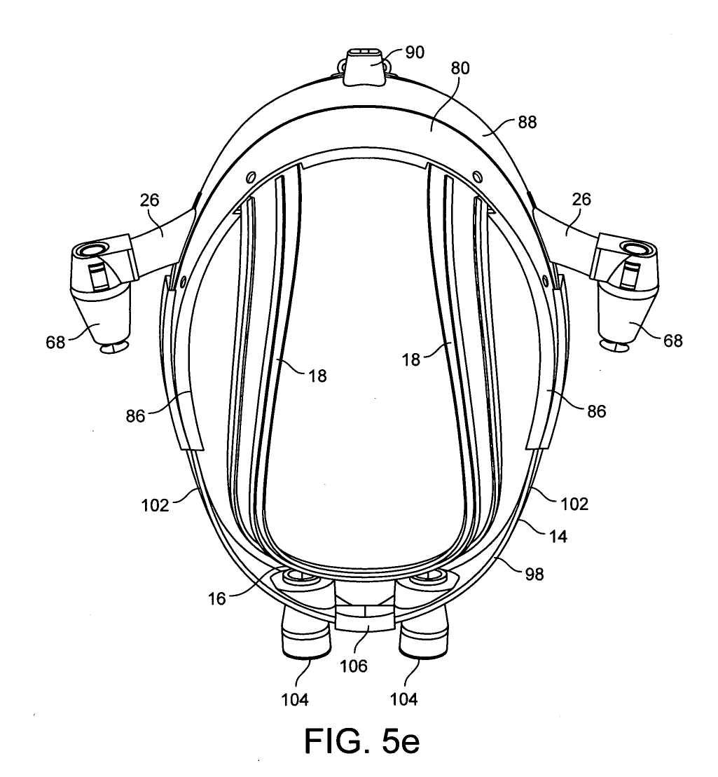

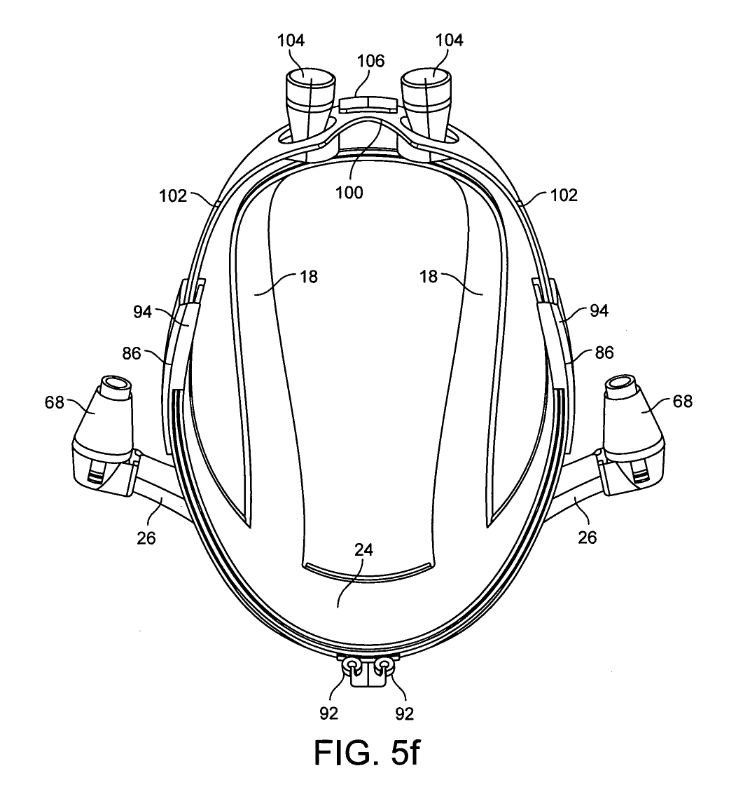

FIG. 5a is a perspective view of a further article of surgical headgear in accordance with the first to fourth aspects of the invention viewed from the front, above and one side,

FIG. 5b is a perspective view of the article of surgical headgear of FIG. 5a viewed from the rear, above and said one side,

FIG. 5c is a side elevation of the article of surgical headgear of FIGS. 5a and b,

FIG. 5d is a front elevation of the article of surgical headgear of FIGS. 5a to c,

FIGS. 5e and f are plan views of the article of surgical headgear of FIGS. 5a to d viewed from above and below respectively,

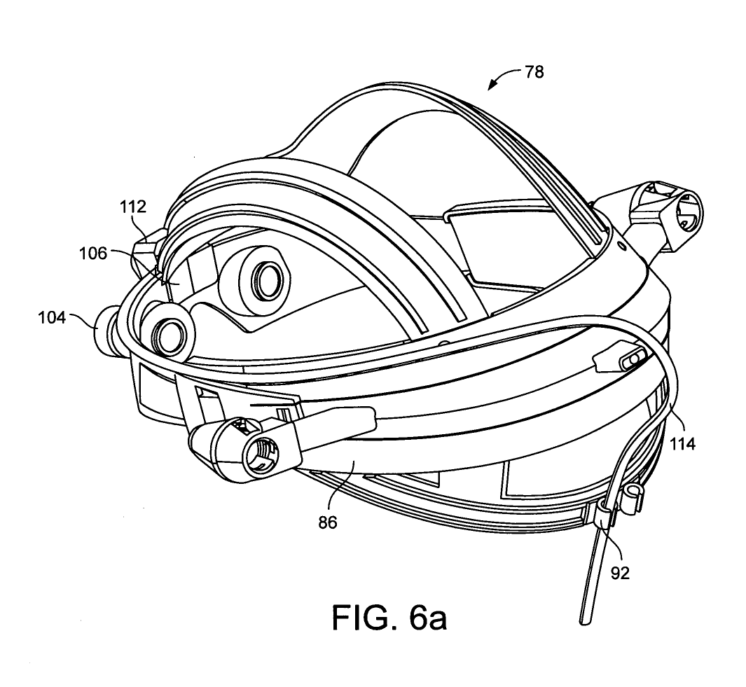

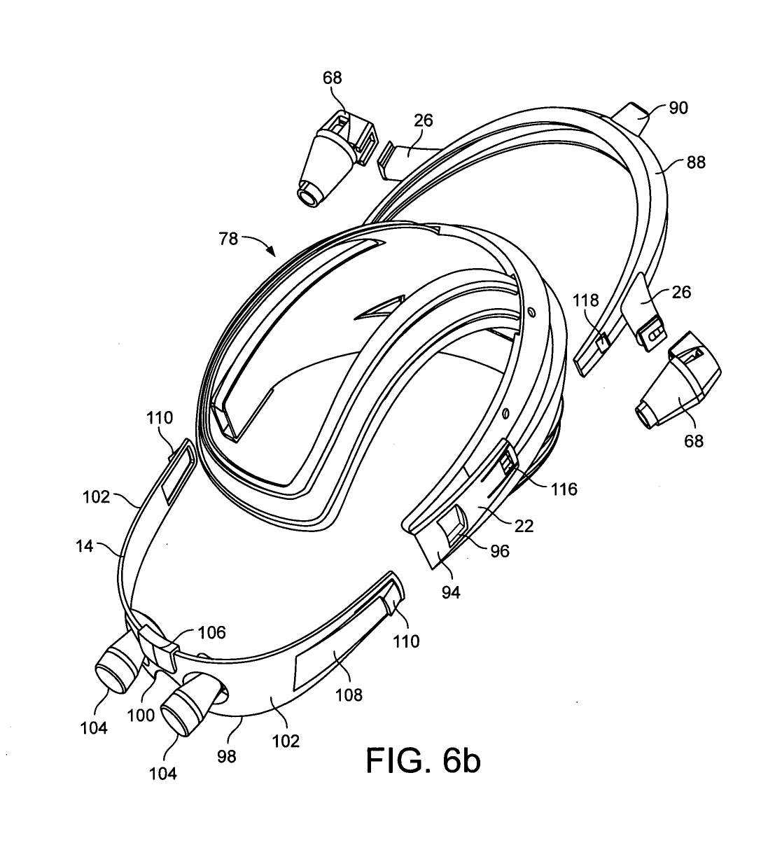

FIG. 6a is a perspective view of the article of surgical headgear of FIGS. 5a to f viewed from the rear, above and the other side with a video camera arrangement mounted thereto,

FIG. 6b is an exploded perspective view of the article of surgical headgear of FIGS. 5a to f, and

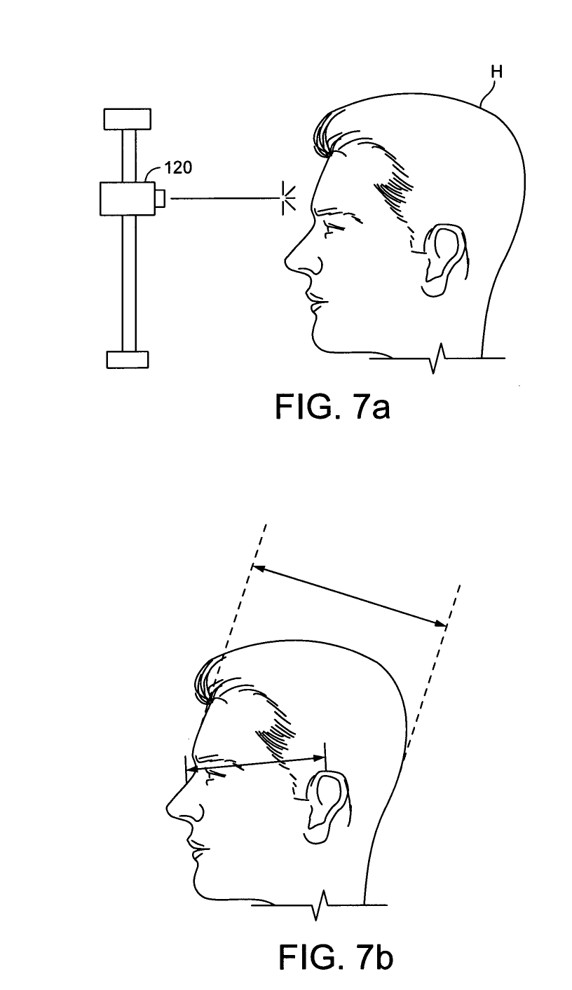

FIGS. 7a and b show schematically a method of fitting such an article of headgear to a user.

In FIGS. 1a to 1d, an article of surgical headgear 10 comprises a headband 12 and a spectacle frame 14 carried by the headband 12 as described below.

The headband 12 is shown on a user's head A and comprises a front curved band part 16 which is arranged to extend around and conforms substantially to a user's forehead B. The front curved band part 16 extends around the forehead B and terminates at each end thereof just before the user's temple C. From each end of the front curved band part, side rails 18 extend. The side rails 18 extend on opposite sides of the user's head A in a semi-circular path which causes the rails to extend over the parietal bones of the skull, generally avoiding the sphenoid and temporal bones and muscles. A crown strap 20 extends from one side rail 18 to the other over the top of the user's head roughly at the crown D thereof.

At the end of each side rail 18 spaced from the front curved band part 16 there is a mounting arrangement 22 for the spectacle frame 14 and beneath that a rear curved band part 24 extends to join the opposite sides of the band together. The rear curved band part 24 extends around the occipital bone region E of the user's head.

Although not shown in detail in FIGS. 1a and 1b, the inner surface of at least the front curved band part, the crown strap and the rear curved band part includes some padding or cushioning to increase the comfort of the headgear to the user. Cushioning can also be incorporated on the inner surface of the side rails 18.

Extending outwardly and forwardly from the rear curved band part 24 on each side of the band beneath the mounting arrangement 22, are respective outriggers 26.

The mounting arrangement 22 comprises part of the band 12 at the end of each of the side rails 18. The band 12 is bifurcated at the mounting arrangement 22 and bows outwardly via step outs 28, 30. The step outs 28, 30 allow room for part of the spectacle frame 14 to pass beneath the headband without causing the headband to bow outwardly or causing pressure to be applied via the band and frame to the user's head. A mounting projection 32 having an enlarged head 34 and a narrow neck 36 extends from the inner surface of the band 12 between the step outs 28, 30. The projection extends inwardly of the band 12 towards the opposite side thereof.

The spectacle frame 14 is formed in two main parts. The first part or camera band 14a comprises a structural member 38 which is generally U-shaped, comprising straight arm parts 40 arranged, respectively, to extend along the opposite sides of the user's head and a curved part 42 which joins the straight arm parts 40 together. The arm parts 40 may be articulated relative to the curved part 42 at an articulation point 44. The structural member 38 includes three mounting clips 46, one at each side and one at the mid point of the curved part 42, which clips mount the second part or lower member 48 of the spectacle frame 14.

The lower member 48 comprises a straight indexing part 50 which extends parallel with and beneath the straight arm part 40 of the structural member 38 with a slight spacing 52 therebetween. Obviously, the lower member 48 includes an indexing part 50 on each side.

A curved vision member 54 extends from the forward end of the indexing part 50 in a curve that is substantially parallel with the curved part 42.

The curved vision member 54 is made from clear pellucid material and has translucent regions 56 and a transparent region 58. The translucent regions are arranged at opposite ends of the curved vision member 54 and the transparent region 58 is arranged centrally between the translucent regions 56. Alternatively, the translucent region 56 may be transparent but provided with tinting and/or shading and/or opaque. The curved vision member 54 includes a cut-out portion 60 at the mid point thereof. The cut-out portion 60 carries, removably, a bridge member (not shown) which is intended to conform with the bridge of the nose of the user.

On either side of the cut-out portion 60, a respective loupe is provided. The loupes 62 are mounted to the transparent region 56 in known fashion, for example by means of an optically clear adhesive. Each loupe is mounted to point downwardly relative to the structural member 38.

The indexing parts 50 of the lower member 48 include a series of regularly spaced markings 64 towards the end thereof.

As can be seen from a combination of FIGS. 1a and 1b, the spectacle frame 14 is mounted to the headband 12 by sliding the mounting projection 32 into the space in 52 between the straight arm part 40 of the structural member 38 and the indexing part 50 of the lower member 48. The narrow neck 36 of the mounting projection 32 is received in the spacing 52 and the enlarged head 34 is arranged inwardly relative to the inner surface of the arm parts 40 and indexing parts 50 so as to retain the narrow neck 36 in the spacing 52. Preferably, the dimension of the spacing 52 and the narrow neck 36 are chosen carefully to create a sliding interference fit between the frame 14 and the headband 12. Alternatively (not shown in FIGS. 1a and 1b), the underside of one or both of the arm parts 40 and indexing parts 50 may include a series of teeth and the enlarged head 34 of the mounting projection 32 may include a ratchet engaging member to enable ratcheting adjustment of the frame 14 relative to the headband 12.

The regular markings 64 on the indexing part 50 can be aligned with the forward edge of one of the bifurcated strap parts of the mounting arrangement 22 and the numbering of the regular marking can be recorded to ensure a repeatably comfortable set-up for the surgeon when donning the headgear.

The mounting arrangement 22 ensures that the headband 12 carries at least a proportion of the weight of the frame 14. Also, two spaced mounting projections 32 can be provided on each of the bifurcated band parts of the mounting arrangement 22, further to support the spectacle frame 14 so as to reduce the loading on the user's nose via the removable bridge. The frame 14 may be supported entirely by the projections 32 so that no weight at all is applied to the bridge.

A wireless video camera 66 is mounted by means of a clip to the front curved band part 16 of the headband 12. The video camera 66 is controlled wirelessly and transmits the video data wirelessly, for example via an infrared or blue tooth connection. The video camera may include onboard power by means of batteries. Alternatively, it may receive power from elsewhere on the headgear or from a separate power supply or elsewhere on the surgeon's body to be described later.

Alternatively, or in addition to the wireless video camera, the frame 14 may carry some means to display “in vision” information, for example, patient's vital signs. The “in vision” display of information may be achieved by the provision of a small screen attached to the frame 14 or integrated within the loupes. Another arrangement comprises a projector to project the information onto the inside surface of the transparent part in the manner of a military head up display.

A lighting unit 68 is mounted to the end of each outrigger 26. Each lighting unit 68 comprises an array of LED's which may include a main array and a supplementary array, all pointing forwardly of the lighting unit 68. The lighting unit 68 is orientated to shine light from the LED's in front of the face of the user. The axis of orientation of the lighting units 68 and the loupes 62 are configured to converge at a point some distance in front of the face of the user. In particular, they are configured to cause the light from both lighting units to converge at the point of focus of the loupes which should be at the point of interest for the surgery, normally around abdomen height for the surgeon. The distance of the point of interest from the head can be raised by altering the orientation and focus of the loupes and lights.

The lighting unit 68 includes vents 70 and may include a small integral fan (not shown) for cooling the lighting unit.

A bracket (72) protrudes outwardly from the rear curved band part 24. The bracket receives, in removable fashion, a power pack 74. The power pack 74 may be filled with conventional batteries, for example AA batteries. Alternatively, the power pack may comprise a self-contained rechargeable lithium ion power unit of the type used to power mobile telephones and laptops.

The headband 12 may include integral wiring such as a power supply bus, a data bus and a control signal bus (not shown). The wireless video camera 66, lighting unit 68 and power pack 74 preferably include contacts for engaging with such a power supply bus and control signal bus and the headband includes corresponding contacts in that respect.

The power pack 74 may additionally carry a micro-processor control which may control the video camera, the lighting unit and monitor power levels. The micro-processor control may also incorporate voice command recognition and/or wireless control systems for wirelessly controlling a video camera and lighting unit (IR/blue tooth or other).

It is envisaged that other useful devices may be incorporated and carried by the headgear. For example, a microphone and earpiece along with remote communication means may be incorporated to enable a surgeon to communicate with medical staff outside the theatre, for example nursing staff, or even to receive instruction remotely. Two way communication is possible with this arrangement.

The power supply may, instead of being mounted at the rear of the headgear be belt mounted and power can be passed to the headgear by means of a cable. The light sources could be belt mounted with light being transmitted via fibre optic cables. The video camera may also include an infra-red camera and/or a thermal imaging camera. The light source may additionally include an infra-red emitter.

As can be seen in the arrangement in FIGS. 1a to 1d the lighting unit and/or power pack acts to counterbalance the weight of the video camera 66 on the front of the headband and the loupes 62 on the front of the spectacle frame 14. The load of the headgear is borne by the user primarily through the side rails 18 and crown strap 20 when the surgeon's head is level. As the surgeon's head tips down to look at the patient, more of the weight of the headgear is taken by the rear curved band part 24 pressing against the occipital bone E of the user. The arrangement shown in FIGS. 1a and 1b avoids pressure on the temple of the surgeon. The prior art surgical headgear arrangement shown in FIG. 3 passes over the sphenoid and temporal bones of the skull and is retained on the head by tightening of the band circumferentially around the surgeon's head which applies significant pressure to those sensitive pressure points at the temples, leading to tension headaches.

In FIG. 1d, an alternative sliding arrangement 75 is shown which receives the arm part 40 and indexing part 50.

Referring to FIGS. 3, 4a and 4b, FIG. 3 shows a prior art surgical headgear arrangement. The fibre-optic cabling for the light source and the power cabling for the video camera are shown running over the head of the surgeon down the back of the surgeon's neck and onto the surgeon's gown as discussed above. As can be seen in FIG. 3, the majority of the weight of the prior art surgical headgear lies at the front of the headgear. FIG. 4a is intended to represent that. In FIG. 4a, the user's head A is shown in an upright level position. In FIG. 4a the point indicated at X is approximately the nodding pivot point of the user's head. The point indicated at Y is the approximate centre of gravity of the prior art surgical headgear. In FIG. 4b, the point indicated at Z is the approximate centre of gravity of the headgear according to the invention. As can be seen, in FIG. 4a, when the user tips his head forwardly, as shown in FIG. 3, the centre of gravity Y of the surgeon headgear will be arranged some distance forwardly of the nodding pivot point X of the user's head A. This means that the headgear is adding to the moment applied on the neck and spine by a surgeon tipping his head downwardly to look at his patient. In the FIG. 4b arrangement where the user is wearing the surgical headgear in accordance with the invention, the centre of gravity is set someway rearwardly of the nodding pivot point of the user's head. Consequently, when the surgeon tips his head downwardly as shown in FIG. 3 to look at the patient, the centre of gravity Z of the surgical headgear in accordance with the invention will move forward but it will move to a point where there is either no additional tipping moment applied to the user's neck or a minimal one. The centre of gravity may even lie behind the nodding pivot point X still so that the headgear slightly counterbalances the tipping moment applied by the surgeon leaning his own head over to look at the patient. It is believed that this arrangement will substantially reduce the strain on the neck muscles when the head is tilted forward into the operating position leading to a reduction in neck and upper back problems including the prolapsed disc that long term use of the existing surgical headgear can cause.

In addition, use of LED's as a light source and the wireless video camera substantially reduces firstly the weight of the headgear in the first place and secondly, the amount of cabling that must be passed along a surgeon's body. A surgeon does not need to be umbilically connected to a light box allowing him greater freedom of movement during the operation process.

Turning to FIG. 2a to 2c, an alternative article of surgical headgear 76 is shown which is similar in many respects to that in FIGS. 1a and 1b. Parts corresponding to parts in FIGS. 1a and 1b carry the same reference numerals.

As stated, the article of surgeon's headgear in FIG. 2 is similar in many respects to that in FIGS. 1a and 1b. However, whereas the article of surgical headgear in FIGS. 1a and 1b comprises a front curved band part, side rails, a crown strap and a rear curved band part, the headband 12 of the article of surgical headgear 76 in FIG. 2 is much simplified. In practice, the band 12 comprises a crown strap 20 and the rear curved band part 24 with the mounting arrangement 22 therebetween. The outriggers 26 carrying lighting unit 68 are in a similar position to that of FIGS. 1a and 1b and the bracket 72 extending from the rear curved band part 24 carries a power pack 74 in similar fashion. However, there is no front curved band part extending around the forehead. Consequently, the wireless video camera is connected to the structural member 38 of the spectacle frame 14. From a mounting, wearing and load-carrying point of view, the arrangement of FIG. 2 is less favourable than that of FIGS. 1a and 1b but the arrangement is more straightforward to manufacture.

The headband in both designs (FIGS. 1a to 1c and FIGS. 2a to 2c) comes in three main parts. The headband 12 or 76, spectacle frame 14 comprising the camera band and the lower member 48. This allows the user to pick and choose which aspects of the headband they want to use for various situations. For example, the user may want to use the loupes (lower member 48) on their own, or just loupes and the camera, or loupes and lights but no camera etc.

In both embodiments of FIGS. 1a, b and FIG. 2, the headband 12 may include some adjustable mechanism. For example, the rear curved band part 24 can be made in two separate sections which can be connected together in any of a number of positions, similar to the adjustment arrangement for hardhat suspension arrangements or baseball caps.

Although the specific embodiments described relate to surgical headgear, it will be appreciated that other uses could be found for the headgear. Also, in the present embodiments, because aesthetics are of low significance in choosing surgical equipment, it should be recognised that the headgear shown in FIGS. 1a, 1b and 2 could form the suspension for a helmet with a more appropriate covering or a protective covering. It could be envisaged that the headgear described with an appropriate hard hat fitting could be used for climbing, caving or pot-holing. Also, we have described various other situations where the present headgear could be of use, such as by the emergency services, tradesmen and craftsmen and cameramen.

The material used for the frames is preferably a plastics material such as a thermoplastic or thermoset. The frames may include padded material on the inside surfaces. The material is preferably reading cleanable and/or sterilisable either by autoclaving, UV irradiation or other known sterilisation method. The material may be impregnated with an anti-bacterial additive, such as that sold under the registered trade mark MICROBAN.

A further article of surgical headgear 78 is shown in FIGS. 5 and 6. The headgear is similar in many respects to that shown in FIG. 1a to 1e and parts corresponding to parts in FIGS. 1a to 1e carry the same reference numerals.

The article of headgear 78 comprises a headband arrangement 12 and a spectacle frame 14 removably mounted thereto. The headband arrangement 12 comprises a front curved band part 16, side rails 18 extending from opposite ends of the front band part 16 and a rear curved band part 24.

The front curved band part 16 is arranged to extend around and coform substantially to the forehead of the user. The side rails 18 are arranged to extend from opposite ends of the front curved band part 16 upwardly over the parietal bones of the user, avoiding the sensitive temple region and the opposite ends of the side rails 18 extend into the rear curved band part 24. The rear curved band part 24 extends around the occipital part of the head of the user and, as shown in the headgear in FIG. 5e on either side of the head so as to define a C-shape in plan to receive the frame 14.

The rear curved band part 24, as shown best in FIGS. 5b and c, comprises a main C-shaped curved body portion 80 with a supplementary C-shaped band 82 spaced beneath the main curved body 80 and connected thereto by means of webs 84. The main body 80 is angled downwardly from the rear forwards and extends around the back of the head at around the junction between the parietal bone and the occipital bone. The supplementary band 82 extends around the back of the head underneath the occipital bone.

The main body 80 of the rear curved band part 24 has side arms 86 which extend forwardly around the side of the head of the user, in use. The side arms 86 carry outriggers 26 similar to the outriggers in the articles of headgear in FIGS. 1 and 2. The side arms 86 also accommodate a mounting arrangement 22 for the spectacle frame 14.

The rear curved band part 24 further comprises a power bus 88 which extends from the centre of the rear curved band part along both side arms 86 and along the outriggers 26 so as to supply power to the lighting units 68 in the outriggers 26. A combined battery pack mounting and electrical connector 90 extends rearwardly of the rear curved band part 24 from the centre of the power bus 88. The battery pack mounting can mount and electrically connect to a battery pack (not shown) similar to that shown in FIG. 1.

The supplementary band 82 is provided with a pair of cable clips 92 which are arranged to receive a variety of cable sizes in snap-fitting resilient fashion. Further such clips may be provided on the side arms 86 or the side rails 18.

The mounting arrangement 22 comprises a sleeve formation 94 on each side arm 86. The sleeve formation 94 is open at the forward end thereof and is sized to receive part of the frame 14. The sleeve formation 94 includes an opening 96 in the outer face thereof.

The spectacle frame 14 comprises a curved body 98 with a cutaway bridge portion 100 cut from the lower edge of the centre of the body 98. Frame 14 further comprises side arms 102. The body 98 carries a pair of loupes 104, arranged one on either side of the bridge portion 100. A video camera mount 106 is arranged on the upper edge of the body 98 above the bridge portion 100 between the loupes 104. Each side arm 102 is provided with a mounting formation 108. The mounting formation 108 comprises a locally thickened region which terminates in a barbed formation 110 (see FIG. 6b). The barbed formation 110 snap-fits into the aperture 96 in the sleeve 94. In order to remove the frame 14 from the headgear 78, the barbed formation 110 can be depressed to allow it to pass back down the sleeve 94. That may require the use of a flat bladed tool or the material may be sufficiently flexible to allow that removal operation to be carried out by hand.

The sleeve 94, opening 96, side arms 102 and mounting formation 108 are preferably dimensioned so that the entire weight of the frame 14 is supported by the mounting arrangements 22 on opposite sides of the article of headgear 78.

In FIG. 6a the article of headgear 78 is shown with a video camera 112 mounted to the video camera mounting 106. A cable 114 for the video camera 12 which both powers the video camera and transmits the video data to a processor runs around the side arm 86 and through the cable clip 92 at the rear of the article of headgear 78.

In FIG. 6b, the article of headgear 78 is shown broken into component form. In FIG. 6b the power bus 88 and outriggers 26 are formed in one separate piece and can be mounted to the main body of the article of headgear by means of the mounting arrangement 22 in similar fashion to the mounting of the spectacle frame 14 described above. In that case, the sleeve 94 is open at both ends and includes a further aperture 116 into which a barbed projection 118 on both sides of the bus 88 can, respectively, project.

The lighting units 68 can slide and lock into position on the ends of the outriggers 26. Those lighting units and outriggers 26 can employ a camera flash style mounting arrangement which includes a mounting and a power coupling.

The arrangement in FIG. 6b is preferred because the surgeon can opt whether or not to employ the lighting units, the power bus and the spectacle frames, as they are all removable and replaceable. The removable and replaceable nature of the spectacle frames allows different powered loupes to be employed. The removable nature of the lighting unit 68 allows the lighting units to be replaced if the lighting unit fails or if a higher powered lighting unit is required. Alternatively, if no lighting unit is required at all, the entire bus and lighting units can be removed.

The headgear in FIG. 6 has the feature of the first aspect of the invention, namely that the headgear includes a lighting arrangement where the centre of gravity of the headgear is rear of the nodding pivot point of the head. It embodies the second aspect of the invention when the lighting or power arrangement is arranged on the rear of the headgear counterbalancing the weight of the spectacle frame arranged on the front. It also embodies the fourth aspect of the invention in which the headgear comprises a band having a front curved part two side parts and a rear part where the two side parts extend over the parietal bones. The headgear also embodies the aspect in which the band is arranged to extend around the head and there is a frame carrying loupes mounted on the band where the band supports the loupes so that no weight is applied to the nose of the user.

In FIG. 7 a method of fitting an article of surgical headgear to a user is shown. The method comprises the steps of scanning the head H of a user with a laser scanning apparatus 120 of known form. Certain key dimensions of the head are then determined from the scan. For example, as shown in FIG. 7b, the distance from the forehead to the rear part of the occipital bone is measured. Likewise, the distance from the bridge of the nose to the ear is measured. Other measurements such as the perimeter of the head or the width thereof and, if necessary, a detailed three dimensional model of the head can be taken. Those dimensions can then be used to design the shape and size of the article of surgical headgear. In that way, the front curved band part 16 as shown in FIGS. 1 and 5 can be arranged to conform closely to the shape of the forehead of the user. The side rails 18 can be arranged to extend over the parietal bones of the user and to fit closely. Likewise, the rear curved band part can be arranged as a snug fit around the occipital bone to ensure that the article of headgear is comfortable and secure on the head of the user during use.

1. An article of headgear for a surgeon comprising a frame, a lighting arrangement on the frame arranged to point generally towards the front of the frame, the headgear being arranged such that, when worn on the head of a user, the centre of gravity of the headgear is arranged rearwardly relative to the nodding pivot point of the head of the user.

2. An article of headgear according to claim 1 in which the lighting arrangement comprises a light source on the frame.

3. An article of headgear according to claim 1 or 2 in which a power supply is arranged on the frame.

4. An article of headgear according to claim 3 in which the power supply is arranged on the rear of the frame.

5. An article of headgear for a surgeon according to claim 4 in which the frame has a front part and a rear part, the front part carrying a piece of optical equipment, the rear part carrying the light source and the power supply whereby the weight of the light source and power supply at least partially counterbalance the weight of the optical equipment or vice versa.

6. An article of headgear for a surgeon according to any preceding claim in which the frame comprises a band for arranging around a part of a user's head, and a spectacle frame for carrying optical equipment adjustable mounted to the band so as to extend, in use, around a user's eyes, part of the band extending, in use, over the crown of the user's head and the band bearing at least part of the weight of the frame.

7. An article of headgear for a surgeon according to any preceding claim in which the article of headgear comprises a band for arranging on a user's head, the band having a front curved band part, two side band parts extending from opposite ends of the front curved band part, the side band parts curving out of the plain defined by the front curved band part, and a rear band part extending between the ends of the side band parts spaced from the front curved band part, whereby, when the article of headgear is worn by a user, the side band parts extend along the parietal bones of the user so as to reduce substantially load applied to the sphenoid or temporal bones.

8. An article of headgear comprising a frame having a front part and a rear part, the front part carrying a piece of optical equipment and the rear part carrying a lighting arrangement or power source, whereby the weight of the lighting arrangement or power source at least partially counterbalances the weight of the optical equipment or vice versa.

9. An article of headgear according to claim 8 in which the frame comprises a band for arranging around a part of a user's head, and a spectacle frame for carrying optical equipment or adjustably mounted to the band so as to extend, in use, the spectacle frame for carrying optical equipment adjustably mounted to the band so as to extend, in use, around a user's eyes, part of the band extending, in use, over the crown of the user's head and the band bearing at least part of the weight of the spectacle frame.

10. An article of headgear according to claim 8 or 9 comprising a band for arranging on a user's head, the band having front curved band part, two side band parts extending from opposite ends of the front curved band part, the side band parts curving out of the plain defined by the front curved band part, and a rear band part extending between the ends of the side band parts and spaced from the front curved band part, whereby, when the article of headgear is worn by a user, the side band parts extend along the parietal bones of the skull to reduce substantially load applied to the sphenoid or temporal bones.

11. An article of headgear comprising a band for arranging around a part of a user's head, a spectacle frame for carrying optical equipment adjustably mounted to the band so as to extend, in use, around a user's eyes, part of the band extending, in use, over the crown of the user's head and the band bearing at least part of the weight of the spectacle frame.

12. An article of headgear according to claim 11 in which the band has a front curved band part, two side band parts extending from opposite ends of the front curved band part, the side band parts curving out of the plain defined by the front curved band part, and a rear band part extending between the ends of the side band parts and spaced from the front curved band part, whereby, when the article of headgear is worn by a user, the side band parts extend along the parietal bones of the skull to reduce substantially load applied to the sphenoid or temporal bones.

13. An article of headgear comprising a band for arranging on a user's head, the band having a front curved band part, two side band parts extending from opposite ends of the front curved band part, the side band parts curving out of the plane defined by the front curved band part, and a rear band part extending between the ends of the side band parts and spaced from the front curved band part, whereby, when the article of headgear is worn by a user, the side band parts extend along the parietal bones of the skull to reduce substantially load applied to the sphenoid or temporal bones.

14. An article of headgear according to any of claims 1 to 10 in which the lighting arrangement and/or the power supply is detachable from the frame.

15. An article of headgear according to claim 14 in which the lighting arrangement is arranged on the frame so as to lie below and spaced outwardly from the ears of the user when the article of headgear is arranged on the user's head.

16. An article of headgear according to any of claim 1 to 10, 14 or 15 in which the lighting arrangement comprises a first light array and a second, supplementary light array.

17. An article of headgear according to any of claims 1 to 10 or 14 to 16 in which the lighting arrangement comprises one or more light emitting diodes.

18. An article of headgear according to any of claims 1 to 10 or 14 to 17 in which the lighting arrangement comprises one, two, or more separate light sources provided on the frame, one on each side of the frame and the light sources are orientated so that light from them converges at a point some distance in front of the frame.

19. An article of headgear according to any of claims 1 to 10 or 14 to 18 in which the lighting arrangement is provided with means to alter the focus of the light beam.

20. An article of headgear according to any of claims 1 to 10 or 14 to 19 in which the lighting arrangement can be remotely activated or voice activated.

21. An article of headgear according to any of claims 8 to 15 in which the optical equipment comprises means for providing an in vision display of information.

22. An article of headgear according to claim 21 in which the in vision display comprises means for projecting information onto the inner surface of a visor carried on the frame.

23. An article of headgear according to any of claims 8 to 12 in which the optical equipment comprises a video camera.

24. An article of headgear according to claim 23 in which the video camera is arranged to operate wirelessly.

25. An article of headgear according to claim 23 or 24 in which the video camera is a digital video camera.

26. An article of headgear according to any of claims 7 to 11 in which the optical equipment comprises high magnification lenses carried on a visor, known as loupes.

27. An article of headgear according to any of claims 8 to 12 and 21 to 26 in which the spectacle frame comprises a nose piece conformed to the nose of the user.

28. An article of headgear according to any of claims 8 to 12 and 21 to 27 in which the spectacle frame comprises a removable nose piece.

29. An article of headgear according to claim 11 or 12 in which the spectacle frame is indexable relative to the band.

30. An article of headgear according to claim 29 wherein the spectacle frame and/or band includes markings to enable the position of the spectacle frame relative to the band to be pre-set.

31. An article of headgear according to any of claims 8 to 12 or 21 to 30 in which the piece of optical equipment is removable from the frame.

32. An article of headgear according to any of claim 11, 12, 29 or 30 in which the spectacle frame is removable from the band.

33. An article of headgear according to any preceding claim in which the article of headgear carries a microphone and audio output along with means for receiving signals from a transmitter/receiver.

34. An article of headgear according to any preceding claim which has integral wiring to provide a power supply bus and/or a signal control bus and at least one set of contacts for connecting an item of equipment to the bus.

35. An article of headgear according to any preceding claim in which the headgear is arranged to receive power from a belt-mounted power supply.

36. An article of headgear according to claim 1 in which the lighting arrangement comprises fibre optic cables transmitting light from a belt mounted light source.

37. An article of headgear according to any preceding claim in which the article of headgear carries or communicates wirelessly with a control device such as a micro-processor.

38. An article of surgical headgear comprising a band arranged to extend at least partly around a head of a user, a frame carrying a pair of loupes, the frame being mounted on the band, the band supporting the frame in such a way that, in use, substantially no weight is applied to the nose of a user.

39. A method of fitting an article of surgical headgear to a user comprising the steps of
scanning the head of the user using a laser scanning arrangement,
using data from the scan to determine a set of dimensions of the head of the user,
using the set of dimensions to design the shape and size of the article of surgical headgear.

40. A method according to claim 39, in which the headgear comprises a headband part and an optical frame part.

41. A method according to claim 40 in which the shape and/or size of the headband part is designed using the set of dimensions.

42. A method according to claim 41 in which the shape and/or size of both the optical frame and the headband part are designed using the set of dimensions.

43. A method according to any of claims 39 to 42 in which the set of dimensions includes two or more of the wrath of the head at particular points, the distance from the forehead to the rearmost point of the occipital bore, the distance from the bridge of the nose to the ears, the perimeter of the head.

44. A method according to any of claims 39 to 43 in which a complete computer model of the head is made.
